(19) United States
(12) Patent Application Publication
(10) Pub. No.: US 2013/0262132 A1
(43) Pub. Date: Oct. 3, 2013

(54) METHODS, APPARATUSES AND COMPUTER PROGRAM PRODUCTS FOR FACILITATING REAL-TIME METRICS IMPACTING BEHAVIOR OF INDIVIDUALS TO OPTIMIZE PERFORMANCE

(71) Applicants: Ashish Sant, Surrey (CA); Ohad Arazi, Vancouver (CA); Aniek Ellis-van Boetzalaer, Richmond (CA)

(72) Inventors: Ashish Sant, Surrey (CA); Ohad Arazi, Vancouver (CA); Aniek Ellis-van Boetzalaer, Richmond (CA)

(73) Assignee: MCKESSON FINANCIAL HOLDINGS, Hamilton (BM)

(21) Appl. No.: 13/436,394

(22) Filed: Mar. 30, 2012

(51) Int. Cl. G06Q 50/22

(52) U.S. Cl. 705/2

(57) ABSTRACT

An apparatus is provided for tracking real time metrics in a health care entity. The apparatus includes at least one memory and at least one processor configured to assign one or more predetermined thresholds to one or more medical events. The processor is further configured to track one or more actions of health care professionals associated with at least one of the medical events of a health care entity in real time. The processor is further configured to compare at least one of the predetermined thresholds to a determined value associated with the actions of the medical event to determine whether the medical event is performed efficiently. Corresponding computer program products and methods are also provided.

### TECHNOLOGICAL FIELD

Embodiments of the invention relate generally to a mechanism of providing health care management and more particularly relate to a method, apparatus and computer program product for providing real-time metrics utilized to improve health care performance.

### BACKGROUND

Currently, health care facilities often utilize radiology imaging to both diagnose and treat medical conditions. At present, reduced reimbursements for imaging and regulatory pressures on radiology typically require imaging departments and radiology practices to become more productive with minimal resources in order to maintain their operational viability/profitability. Currently, there have been many attempts to improve overall workflow via integrations, data flow and department level offline dashboards to measure performance indicators relating to radiology health care. However, at present there is not much focus on identifying ways to improve the productivity of individuals in order to improve the overall operational efficiencies of clinicians in radiology environments.

Moreover, enhanced regulatory oversight by entities such as the Food and Drug Administration (FDA), the Centers for Medicare & Medicaid Services (CMS), the Joint Commission and the American College of Radiology have placed a strong emphasis on quality outcomes within radiology. As a result, the role of the radiologist is evolving from image interpretation to broader engagement with patients and other physicians in the context of a multi-disciplinary care teams. For example, at present radiologists are being required to spend more of their time reviewing the outputs of various health care professionals such as residents (e.g., resident physicians), fellows (e.g., doctoral researchers), other radiologists, emergency room physicians and to consult a referring physician and other specialists regarding the outcomes of the radiology image interpretation process. Without measurable indicators as to the contribution, volume or throughput of these non-interpretive quality related tasks, radiologists are challenged to maximize productivity and balance image interpretation activities with consultative responsibilities.

Generally, the focus on personal productivity and quality outcomes within radiology has been via improving product performance and usability, but typically not by users with any real time indicators regarding how they are doing from a results/outcome perspective, nor quantifying their involvement in consultative quality-related activities outside of the image interpretation process. Similarly, any solutions that use departmental dashboards for metrics typically use trailing indicators (e.g., data for a previous month, etc.) for an entire health facility or department and are reviewed/managed by administrators with policy and process changing authority. The information/parameters (e.g., performance parameters) associated with the trailing indicators are typically applied globally for a radiology department/facility and generally do not help an end user such as a health care processional monitor/improve their performance in real time.

As an example, the trailing indicators may be associated with information captured over a previous time period indicating, for example, how long it took on average during a previous month for patients to wait in a waiting area, how long it took on average to examine patients, or how long it took on average during a prior month to generate a report regarding an examination of patients, etc.

This trailing indicator information may be analyzed by administrators of radiology that make policy and process changes to determine changes that should be made such as corrective measures.

A drawback with using trailing indicator information to determine corrective measures is that the trailing indicator information typically gets reviewed, for example, on a weekly, monthly or quarterly basis. As such, corresponding corrective measures (e.g., examining patients faster) determined by administrators to entice health care professionals to change their behavior or act on some policy or changes are not communicated to health care professionals of a radiology facility to entice the health care professionals in real time but rather after some time period. Since the corrective measures are typically not indicated to the health care professionals in real time, as corresponding actions occur, but rather after a time period, the health care professionals' behavior may eventually regress or revert back to their previous behavior. The behavior of the health care professionals may regress or revert back to prior behavior since they may have to wait till another review period to be reminded of corrective measures and goals.

Moreover, latency in applying corrective measures in response to trailing indicator information may result in adverse quality outcomes, as clinical decisions are routinely based on reports from radiologists. For example, consistent mis-diagnosis of a particular type of breast nodule by a radiologist due to a lack of training may cause multiple unnecessary mastectomies before the recurring error is revealed in a monthly peer review report. Real time indicators as to the number and quality of peer reviews being conducted for any given radiologist may greatly minimize the response time in applying corrective measures, reducing potential harm to patients.

Another drawback is that existing metrics typically do not provide benchmarks that may be used to compare with individual metrics for determining productivity in real time.

In view of the foregoing drawbacks, it may be beneficial to provide an efficient and reliable mechanism for providing information to health care professionals to optimize productivity.

### BRIEF SUMMARY

A method, apparatus and computer program product are therefore provided that may enable the provision of one or more metrics in real time that may be utilized to optimize performance and productivity in a health care system.

An example embodiment may provide information to one or more health care professionals constantly in real time in a non-intrusive manner but which may be visible as the health care professionals perform their day-to-day work activities in order to influence their behavior in a more effective/efficient manner, or to inform their peers/supervisors of relevant behavioral data that may require action on their part.

As such, an example embodiment may enable a communication device to provide visible indicia to health care professionals in real time as they perform tasks independent of their day-to-day workflow and to change or influence their behavior such that benefits are realized far sooner and to motivate a health care professional to make changes in their behavior rather than waiting to be told to change behavior retrospectively.

In other words, the instant feedback provided by a communication device of one or more example embodiments may allow one or more health care professionals to adjust their workflow and their behavior accordingly and take action to make an immediate difference to achieve one or more targeted goals. The targeted goals may be goals for a health care entity (e.g., a radiology facility, etc.) or may be individual goals for the health care professionals.

Some example embodiments may provide health care professionals with constant feedback in real time as they are using one or more applications or performing one or more actions/tasks associated with medical events in order to provide feedback in many areas. For example, a communication device of an example embodiment may provide feedback in real time to one or more health care professionals in relation to time taken between different steps in the workflow of the health care providers, and in certain cases may positively impact patient outcomes. For example, a real time indication for the time elapsed for communicating a critical finding may alter the behavior of a radiologist to ensure that a patient is contacted for a follow up procedure, before the patient has left the hospital following a radiology study being performed. Additionally, a communication device of an example embodiment may provide feedback in real time to one or more health care professionals in relation to specific goals or targets that they have in terms of compliance requirements, in terms of their individual or departmental productivity, or any other suitable reasons.

In one exemplary embodiment, a method for tracking real time metrics in a health care entity is provided. The method may include assigning one or more predetermined thresholds to one or more medical events. The method may further include tracking one or more actions of health care professionals associated with at least one of the medical events of a health care entity in real time. The method may further include comparing at least one of the predetermined thresholds to a determined value associated with the actions of the medical event to determine whether the medical event is performed efficiently.

In another exemplary embodiment, an apparatus for tracking real time metrics in a health care entity is provided. The apparatus may include a memory and a processor configured to cause the apparatus to assign one or more predetermined thresholds to one or more medical events. The processor is further configured to cause the apparatus to track one or more actions of health care professionals associated with at least one of the medical events of a health care entity in real time. The processor is further configured to cause the apparatus to compare at least one of the predetermined thresholds to a determined value associated with the actions of the medical event to determine whether the medical event is performed efficiently.

In another exemplary embodiment, a computer program product for tracking real time metrics in a health care entity is provided. The computer program product includes at least one computer-readable storage medium having computer-executable program code instructions stored therein. The computer-executable program code instructions may include program code instructions configured to cause the apparatus to assign one or more predetermined thresholds to one or more medical events. The computer program product may further include program code instructions configured to track one or more actions of health care professionals associated with at least one of the medical events of a health care entity in real time. The computer program product may further include program code instructions configured to compare at least one of the predetermined thresholds to a determined value associated with the actions of the medical event to determine whether the medical event is performed efficiently.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of communication device according to an exemplary embodiment of the invention;

FIG. 3 is a schematic block diagram of a computing device according to an exemplary embodiment of the invention;

FIG. 4 is a diagram of a user interface illustrating a weekly reporting goal summary according to an exemplary embodiment of the invention;

FIG. 5 is a diagram of a user interface illustrating an expanded weekly reporting goal summary according to an exemplary embodiment of the invention;

FIG. 6 is a diagram of a user interface illustrating weekly reporting goal preferences according to an exemplary embodiment of the invention;

FIG. 7 is a diagram of a user interface illustrating weekly reporting goal updates according to an exemplary embodiment of the invention;

FIG. 8 is a diagram of a user interface illustrating a weekly peer review goal summary according to an exemplary embodiment of the invention;

FIG. 9 is a diagram of a user interface illustrating an expanded weekly peer review goal summary according to an exemplary embodiment of the invention;

FIG. 10 is a diagram of a user interface illustrating weekly peer review goal preferences according to an exemplary embodiment of the invention;

FIG. 11 is a diagram of a user interface illustrating weekly peer review goal updates according to an exemplary embodiment of the invention; and

FIG. 12 is a flowchart of an exemplary method for tracking real time metrics in a health care system according to an exemplary embodiment of the invention.

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As used herein, a STAT exam or a STAT read may be referred to interchangeably to denote an urgent exam reading of medical images, for generating a diagnosis, which requires immediate attention. Also, as used herein, a routine exam or routine read may be referred to interchangeably to denote an exam reading of medical images, for generating a diagnosis, which may, but need not, be performed in a non-expedited manner.

As referred to herein, real time may denote an actual (e.g., current) time during which one or more events take place or occur.

An example embodiment may provide information in real time to one or more communication devices of users in a system. The information (e.g., metrics) may be provided in real time while the users (e.g., health care professionals) are working on day-to-day activities allowing for instant follow-up by the users in adapting/improving/optimizing their performance and improving an overall performance/productivity of a health care facility such as, for example, a radiology facility. In this regard, faster throughput within a health care facility (e.g., a radiology department) and faster delivery of the exam results to referring physicians may be achieved. In an example embodiment, a communication device may quantify information that may serve as a basis for evaluating overall contribution of a health care professionals (e.g., a radiologist(s), a radiologist technician, etc.) to a care process, both in productive use of time for image interpretation and reporting, as well as consultative activities that contribute to the overall quality of patient care. The responsiveness to immediate tracking of performance and quality of an exemplary communication device may show quick results and may also support sustaining desired behavior over longer periods of time as compared to similar analysis done based on past data (e.g., training indicator information) due to the lack of relevance between the data being analyzed and the actions a user can take on a day-to-day basis.

In an example embodiment, a communication device may provide one or more health care professionals with monthly reports regarding the time taken to approve a report after it is transcribed which may have an immediate impact on the behavior of the health care professionals after one or more of the reports are received. In another example embodiment, a communication device may provide a health care professional(s) (e.g., a radiologist(s)) with real time information relating to the number of peer reviews that are completed and a comparison to a department's benchmark for completing peer reviews. This may allow a health care facility (e.g., a radiology department) to ensure quality is adhered to on an ongoing real time basis, as opposed to compared data that is analyzed after some time period identifying uncompleted peer review cases, for example.

Comparatively, in an instance in which data is visible constantly and in real-time, then a health care professional (e.g., a radiologist(s)) may optimize their work in such a way that improvements are visibly indicated on a communication device instantly and may be sustained over longer periods of time due to constant feedback on the performance of the health care professional(s).

### General System Architecture

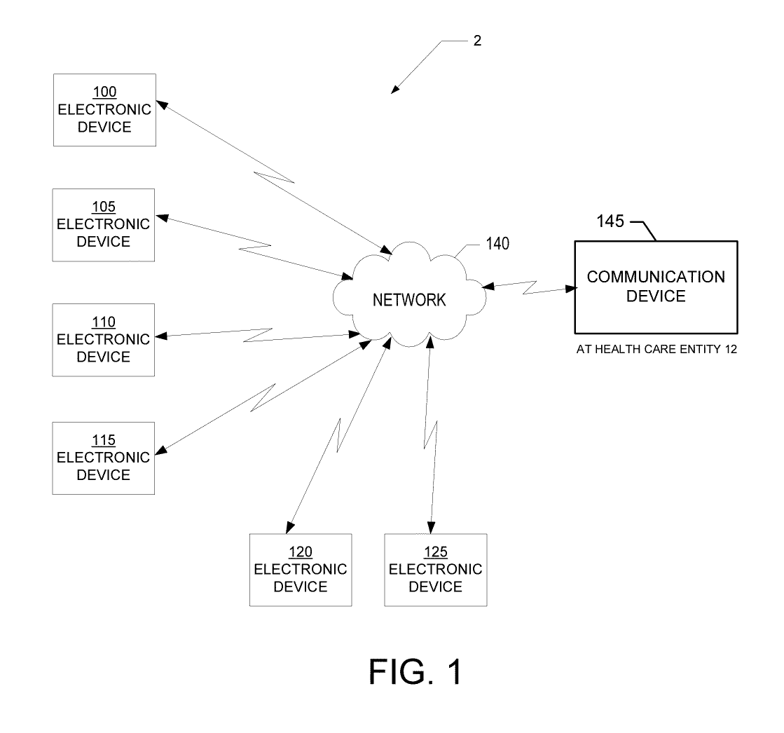

Reference is now made to FIG. 1, which is a block diagram of a system according to exemplary embodiments. As shown in FIG. 1, the system 2 may include one or more electronic devices 100, 105, 110, 115, 120 and 125 (e.g., personal computers, laptops, workstations, servers, personal digital assistants, smart devices and the like, etc.) which may access one or more network entities such as, for example, a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 145 is capable of receiving data from and transmitting data to the electronic devices 100, 105, 110, 115, 120 and 125 via network 140. In one exemplary embodiment, the electronic devices 100, 105, 110, 115, 120 may be utilized by clinicians, nurses, pharmacists, physicians (e.g., radiologists), medical technicians (e.g., radiation technologists), physical therapists and/or any other suitable health care professionals. The electronic devices 100, 105, 110, 115, 120, 125 may be maintained by one or more health care institutions. The health care institutions may include, but are not limited to hospitals, universities, clinics, radiology facilities, etc. In an exemplary embodiment, the communication device 145 may be maintained by a health care entity 12. In an alternative exemplary embodiment, the communication device 145 may be maintained by any other suitable entity.

The communication device 145 may communicate with the electronic devices 100, 105, 110, 115, 120, 125. In this regard, the communication device 145 may receive medical information from and may transmit medical information (e.g., medical images, peer reviews, medical exams, etc.) to the electronic devices 100, 105, 110, 115, 120, 125.

It should be pointed out that although FIG. 1 shows six electronic devices 100, 105, 110, 115, 120, 125 and one communication device 145 any suitable number of electronic devices 100, 105, 110, 115, 120, 125 and communication devices 145 may be part of the system of FIG. 1 without departing from the spirit and scope of the invention.

### Communication Device

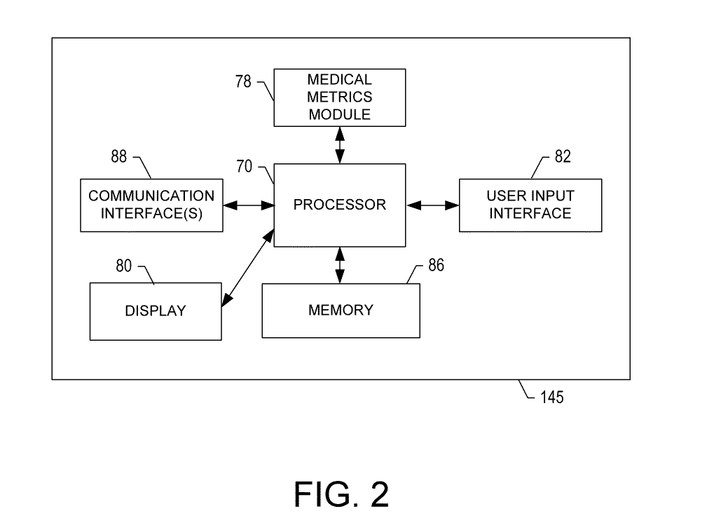

FIG. 2 illustrates a block diagram of a communication device according to an exemplary embodiment of the invention. The communication device 145 may, but need not, be a network entity such as, for example, a server. The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 145 may include a processor 70 connected to a memory 86. The memory may comprise volatile and/or non-volatile memory, and typically stores content (e.g., media content), data, information or the like.

For example, the memory 86 may store content transmitted from, and/or received by, the electronic devices 100, 105, 110, 115, 120 and 125. In this regard, in an exemplary embodiment, the memory 86 may store data received from various disparate sources. For example, the memory 86 may store medical information received by the communication device 145 from the one or more hospitals (e.g., a radiology department of a hospital), universities (e.g., a medical department of university), clinics, laboratories, radiology facilities and any other suitable health care facilities. The medical information may include, but is not limited to, medical images, peer reviews, baseline/benchmark data (e.g., data corresponding to tasks of one or more radiology facilities), medical exams (e.g., STAT exams), medical studies (e.g., diagnoses of medical images) and any other suitable information.

Also for example, the memory 86 typically stores client applications, instructions, algorithms or the like for execution by the processor 70 to perform steps associated with operation of the communication device 145 in accordance with embodiments of the invention. As explained below, for example, the memory 86 may store one or more client applications such as, for example, software (e.g., software code also referred to herein as computer code).

The processor 70 may be embodied in a variety of ways. For instance, the processor 70 may be embodied as a controller, coprocessor microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, electronic devices 100, 105, 110, 115, 120, 125 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a medical metrics module 78. The medical metrics module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the medical metrics module 78, as described below. In examples in which software is employed, a device or circuitry (e.g., processor 70 in one example) executing the software forms the structure associated with such means. As such, for example, the medical metrics module 78 may be configured to, among other things, generate one or more items of information in real time that may be utilized to enable optimization and productivity of one or more health care professionals, as described more fully below.

### Computing Device

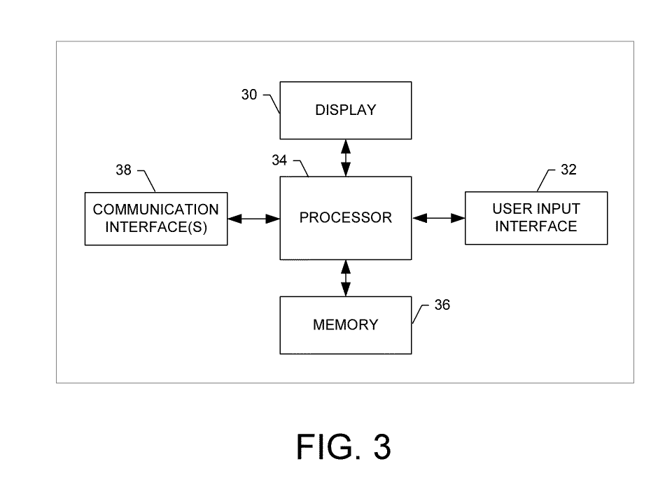

Referring now to FIG. 3, a block diagram of a computing device according to an exemplary embodiment is provided. The computing device is capable of operating as any of electronic devices 100, 105, 110, 115, 120 and 125. In this regard, the electronic devices 100, 105, 110, 115, 120, and 125 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code) algorithms, instructions or the like for the processor 34 to perform steps associated with operation of the computing device. The memory device 36 may also store medical information (e.g., medical image diagnoses, medical images, peer reviews, medical studies, etc.) associated with one or more patients.

The processor 34 may be embodied in a number of different ways. For example, the processor 34 may be embodied as one or more of various hardware processing means such as a coprocessor, a microprocessor, a controller, a digital signal processor (DSP), or various other processing circuitry including integrated circuits such as, for example, an application specific integrated circuit (ASIC). In an example embodiment, the processor 34 may be configured to execute instructions stored in the memory device 36 or otherwise accessible to the processor 34.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display, or any other input device.

### Exemplary System Operation

Exemplary embodiments of the invention may provide an efficient and reliable mechanism for utilizing information in real time to optimize behavior of one or more health care professionals. In this regard, an example embodiment may provide instant real-time metrics to devices of users that may impact the behavior of the users to improve overall quality of patient care.

In an example embodiment, a communication device may provide health care professionals with access to real-time metrics regarding their performance, activities, and involvement in the overall process of patient care. In this regard, health care professionals may choose to adapt their behavior to improve their individual metrics, as described more fully below. The improvements resulting from the change in the pattern or behavior of the health care professionals may be shown via a display of a communication device.

Exemplary embodiments may utilize notions of immediate gratification, in which a health care professional(s) has instant access to the results of their changed behavior which may encourage feelings towards effecting behavioral changes, and may influence health care professionals to adapt their behavior in real-time rather than changing any behavior on the basis of information (e.g., trailing indicators) provided at subsequent time periods (e.g., during a review of correct measures on a weekly, monthly, quarterly basis, etc.)

As examples in which the medical metrics module 78 may provide information to optimize performance and productivity in one or more health care systems, consider the following exemplary embodiments described more fully below for purposes of illustration and not of limitation. It should be pointed out that in some of the exemplary embodiments described below, some of the metrics may relate to identified personal level goals, productivity in association with other peers and/or department level goals in comparison to an indication as to the manner in which a health care professional stands with respect to meeting the departmental goals. In other words, some of the metrics may be applicable to monitoring behavior or characteristics of: individuals (e.g. a radiologist, a radiologist technician) of a health care facility; and/or a group of individuals (e.g., a group (e.g., a radiology department) of health care professionals (e.g., radiologists)) within an organization (e.g., peer review board) or health care facility. Additionally, in the exemplary embodiments described below, one or more health care institutions (e.g., a radiology facility, an imaging center, a medical department of a university, etc.) may utilize the medical metrics module 78 to set or define one or more goals and thresholds (e.g., baseline/benchmark data) for monitoring one or more conditions and the medical metrics module 78 may provide data in real time indicating the manner in which the health care institutions or individuals (e.g., health care professionals) of the health care institutions are performing against one or more corresponding goals, as described more fully below. The health care institutions may set these goals based in part on their business, patient safety and/or quality of service factors as well as any other suitable reasons and the medical metrics module 78 may trigger the display 80 to show data indicating whether individuals or groups are meeting the goal(s) on a health care system level in real time.

For purposes of illustration and not of limitation, in an example embodiment, the medical metrics module 78 may monitor system level metrics in real time. The system level metrics may be predefined for monitoring by the medical metrics module 78 based in part on receipt of input from one or more health care professionals (e.g., health administrators, radiologists, radiologist technicians, etc.) of one or more health care facilities (e.g., a radiology center). In this example embodiment, the predefined system level metrics to be monitored in real time may include system level averages for performing STAT reads (e.g., a time from when a STAT exam is performed to a time when the STAT exam is read) by radiologists, or a number of unread studies (e.g., imaging exams) in a health care facility (e.g., a radiology center, etc.). Additionally, the predefined system level metrics to be monitored in real time by the medical metrics module 78 may include, but are not limited to, system averages for dictating an exam (e.g., a time in which an exam is performed to a time in which results of the exam are dictated). Furthermore, the predefined system level metrics to be monitored in real time by the medical metrics module 78 may include, but are not limited to, times for reporting an exam to a transcriber and for radiologists signing a transcribed report generated by the transcriber. The predefined system level metrics to be monitored in real time by the medical metrics module 78 may also include any other suitable system level metrics.

The medical metrics module 78 may detect the times of events (e.g., times in which STAT reads are performed, times for reporting exams to transcribers, times for radiologists to sign reports (e.g., transcribed reports, etc.) in a health care facility (e.g., a radiology center, a hospital, etc.) based in part on examining time stamp information indicating the times of the events. The time stamp information may be captured by one or more applications being executed by the processor 70 and may be provided to the medical metrics module 78.

Each of the system level metrics described above may be compared to a predetermined threshold to indicate to an individual (e.g., a health care professional (e.g., a radiologist)) or a group of individuals (e.g., individuals of a department) of a health care facility (e.g., a radiology center) the manner in which they are performing against the system level metrics, as described more fully below. The predefined thresholds may be defined by the metrics module 78 in response to receipt of input specifying the thresholds by a health care professional. As an example, the medical metrics module 78 may receive an indication specifying that an average time for performing a STAT read is five minutes. The indication may be based on receipt of input by a health care professional via the user input interface 82 indicating an average time for performing a STAT read is five minutes. In response to receipt of the information indicating the average time for performing the STAT read, the medical metrics module 78 may generate a predetermined threshold of five minutes for performing a STAT read. The medical metrics module 78 may store the predetermined threshold in memory 86.

As such, in an instance in which the medical metrics module 78 monitors a detected STAT read and determines that a health care professional (e.g., a radiologist) takes ten minutes to perform a STAT read, the medical metrics module 78 may determine that the health care professional exceeds the desired time (e.g., exceeds the predetermined threshold (e.g., five minutes)) for performing a STAT read within a health care facility (e.g., a radiology center). In this regard, the medical metrics module 78 may provide visible indicia to one or more displays (e.g., display 30, display 80) indicating to the health care professional in real time that the health care professional is taking more time than desired for performing STAT reads. The visible indicia shown via the displays (e.g., display 30, display 80) indicating that the health care professional exceeds the desired time (for example, by five minutes) may cause the health care professional to alter behavior and perform STAT reads faster.

In one example embodiment, the medical metrics module 78 may provide visible indicia to one or more displays (e.g., displays 30) of electronic devices (e.g., electronic device 100, 105, 110, 115, 120, 125). The visible indicia may indicate that the entire health care facility (e.g., each of the radiologists of a radiology center) is performing according to an average such as, for example, performing STAT reads within five minutes of receipt of corresponding medical images.

The medical metrics module 78 may determine the time that it takes the health care professional (e.g., a radiologist) to perform the STAT read based in part on examining time stamp information indicating a time in which the health care professional began the STAT read and another time in which the health care professional completed the STAT read.

In one example embodiment, the medical metrics module 78 may monitor a number of studies (e.g., medical images) that are unread by analyzing data indicating, for example, that the studies are in a queue and awaiting confirmation that the studies have been reviewed and diagnosed. In an instance in which the medical metrics module 78 determines that the number (e.g., ten) of unread studies exceeds a predetermined threshold (e.g., seven) of unread studies, the medical metrics module 78 may provide visible indicia, in real time, to one or more displays (e.g., display 80, display 30) indicating that the number of unread studies in the queue is above the predetermined threshold and is higher than desired based on the predefined goals of a health care facility. This indication provided to one or more displays that the number of unread studies in the queue is above the predetermined threshold may influence the behavior of one or more health care professionals to review the unread studies to comply with the predefined goals of the health care facility (e.g., a radiology center).

In an another example embodiment, the medical metrics module 78 may detect a time in which a health care professional(s) (e.g., a radiologist(s)) dictates their diagnosis regarding one or more medical images based in part on receipt of an indication by the health care professional indicating that the diagnosis is dictated. The dictation of the diagnosis may be captured by a recording of the voice of the health care professional(s) (e.g., the radiologist). Additionally, the medical metrics module 78 may detect a time in which a transcriber listens to the voice recording, transcribes the voice recording and a time in which health care professional approves the transcription (e.g., a transcription report).

In an instance in which the medical metrics module 78 determines that a time period associated with the start of the generation of the dictation up to an instance in which the transcription is detected by the health care profession as complete and accurate. The transcription may be detected as complete and accurate in response to receipt of an indication, by the medical metrics module 78, that the health care professional approved the transcription. In response to determining that the time period exceeds a predetermined threshold (e.g., a predetermined threshold of three hours) the medical metrics module 78 may generate an indication denoting that the time period is exceeded (e.g. five hours has elapsed and the transcription is incomplete or not confirmed as accurate). In this regard, the medical metrics module 78 may provide visible indicia to one or more displays (e.g., display 30, display 80) indicating that the predetermined threshold is exceeded. An indication that the predetermined time period is exceeded may influence a health care professional and/or a transcriber to complete the transcription and review the transcription to indicate that the transcription is complete and accurate.

In another example embodiment, the medical metrics module 78 may utilize one or more statistical reports to generate one or more metrics related to consultative, quality-driven activities such as, for example, participation in tumor board meetings (TBM), multi-disciplinary team (MDT) meetings (MDT), creation of teaching files, reporting critical findings to ordering physicians, image quality reviews for technologists, conducting peer and resident reviews and sub-specialty over-reads and any other suitable metrics). Currently, existing solutions (e.g., dashboard services) typically do not accurately log and monitor these activities and as a result have not been quantified as Relative Value Units (RVUs) which are typically the basis for the professional reimbursement of radiology services. Relative value units may be utilized to determine how productive a radiologist is in terms of providing radiology services. In this regard, analysis of RVUs may be beneficial in obtaining reimbursement (e.g., reimbursement by an insurance company) by a radiologist(s) for radiology services.

In an example embodiment, a radiologist may have an affiliation with a teaching hospital (e.g., an academic institution that is part of a university which is also associated with a hospital) in which the radiologist is required to conduct certain types of teaching events and in which medical information may be shared and lessons may be taught regarding radiology and other medical disciplines. The teaching hospital may set an internal goal for radiologists specifying that every radiologist would contribute a number (e.g., 100) of medical exams (e.g., studies/diagnoses pertaining to medical images) per month out of total number (e.g., 2,000) of medical exams they read to aid and assist with teaching of the residents. This information indicating the goal regarding the number of medical exams that a radiologist is designated to contribute during a time period (e.g., per month) may be defined as a predetermined threshold by the medical metrics module 78 and may be stored in the memory 86.

In this regard, for example the medical metrics module 78 may monitor and measure the performance of the radiologist regarding their findings and contributions into a database (e.g., a teaching file database) of a memory (e.g., memory 86) to ensure, for example, that residents are capable of reviewing enough interesting medical exams. As such, a tumor board or other multi-disciplinary team(s) may be aware in real time that the radiologist is providing a sufficient amount of cases (e.g., medical exams) for discussion or teaching purposes such that there is a mutual benefit to the academic community in the teaching hospital.

For purposes of illustration and not of limitation, in one example, a hospital board might set some goal for radiologists (or a radiologist may set their own goal) within the teaching community specifying that every radiologist is expected to contribute 100 medical exams per month into a database (e.g., a database of memory 86). In this regard, the medical metrics module 78 may designate the 100 medical exams per month as a predetermined threshold. As such, the medical metrics module 78 may track/monitor an instance in which there are 20 medical exams stored in the database of the memory for a given month and may compare this to the predetermined threshold (e.g., 100 medical exams per month). In this example embodiment, the medical metrics module 78 may provide visible indicia to a display(s) (e.g., display 80, display 30) indicating the current number (e.g., 20) of medical exams stored in the database on behalf of the radiologist. In this regard, the radiologist may know he may not have a sufficient amount of medical exams analyzed and stored in the database before a scheduled hospital board meeting (e.g., a tumor board meeting) or before the end of the month.

Moreover, in this example embodiment, one or more members of the hospital board (e.g., the tumor board) may utilize devices such as one or more of electronic devices 100, 105, 110, 115, 120, 125 and may view (during the meeting for example) a display (e.g., display 30) of an electronic device (e.g., electronic device 100) showing that the radiologist only contributed 20 medical exams to the database of the memory 86. In this manner, the members of the hospital board may also determine how many medical exams have been provided to the database by other radiologists. For example, the board members may determine that Dr. Joe Doe (e.g., a fictitious physician) submitted 20 medical exams and Dr. John Doe (e.g., another fictitious physician) only submitted two medical exams. As such, the board members may know that Dr. John Doe is significantly behind in submissions of the medical exams even before the end of the month. Since Dr. John Doe is significantly behind, the medical board may determine that Dr. John Doe is unproductive/inefficient during the particular month.

As described above, some example embodiments may utilize statistical reports for metrics associated with critical findings. In this regard, at present there is a regulatory requirement specifying that in an instance in which a finding is critical, a radiologist has an obligation to contact a patient's primary care physician right away to inform the primary care physician of the critical finding. Some critical findings may have different classifications regarding what constitutes a critical finding. Suppose for example that a patient needs to go into surgery right away and he or she could not wait for their next appointment with their primary care physician to discuss what needs to be done.

In this example, presume that the diagnosis relates to a serious medical condition such as, for example, a brain tumor and as such a patient needs to go into surgery right away. Such a condition may relate to a critical finding and a radiologist may have an obligation to contact a primary care physician and inform the primary care physician that their patient needs to go into surgery right away.

It is typically insufficient for the radiologist to merely attempt to contact the primary care physician, such as, for example, by sending an e-mail, a fax message or making a phone call to the primary care physician. Instead, the radiologist may need to get confirmation back from the primary care physician that the message of the radiologist was received indicating that the patient is in a critical condition and required to have surgery immediately. Given the important nature of critical findings, the critical findings may need to be tracked. As such, for example, the medical metrics module 78 may track or monitor instances in which the radiologist has five identified critical findings outstanding which have not been closed yet with the primary care physician. As such, the medical metrics module 78 may generate an alert every half hour reminding the radiologist to contact the primary care physicians associated with the patients again until confirmation is received by the primary care physicians that they received the message indicating that their patient is in a serious condition and that the patient requires immediate attention (e.g., surgery).

In this regard, the critical findings reporting of an example embodiment may utilize metrics in real time to indicate whether a radiologist has confirmed with a primary care physician that patient of the primary care physician is in a critical condition requiring immediate medical attention. Capture of indications of the number of outstanding critical findings that have not been confirmed by primary care physicians may indicate to a hospital board or the like whether a radiologist is performing their work in a timely fashion and the radiologist is able to obtain instant feedback from the medical metrics module 78 indicating whether the radiologist is keeping up with requirements.

In some example embodiments, health care professionals (e.g., radiologists) may be provided real time feedback on individual performance, by the medical metrics module 78, based on one or more metrics associated with assigning studies to health care professionals (e.g., radiologists) at the time of an exam(s).

For purposes of illustration and not of limitation, in an example embodiment, a health care facility (e.g., a radiology center) may assign three radiologists to examine medical exams and whoever is available first may analyze a next medical exam for a reading of medical images. On the other hand, some other health care facilities may plan the allocation of the workload for examining medical exams differently such as, for example, by assigning workload evenly. For instance, the health care facility may specify that a first radiologist (e.g., Dr. Smith (e.g., a fictitious doctor)) evaluates a number of exams (e.g., 15 exams) and a second radiologist (e.g., Dr. John (e.g., a fictitious doctor)) is designated to evaluate a number of other medical exams (e.g., 15 exams) In this manner, health care facilities may minimize the impact of radiologists selecting the medical exams to perform of their choice since performing some exams may result in higher fees.

In this example embodiment, the radiologists may utilize the user input interface 82 to specify an instance in which the radiologists are finish reviewing corresponding medical exams. The medical metrics module 78 may analyze this information and provide visible indicia to displays (e.g., display 80, display 30) such that the radiologist and/or administrators of health care facilities may analyze this displayed information to determine whether the radiologist is efficiently reviewing the medical exams in a timely manner or taking too long. In instances if which the displayed data indicates that a radiologist is taking too long to review medical exams an administrator of a health care facility may reallocate the radiologists previously assigned medical exams to other radiologists that are more efficient.

As such, the medical metrics module 78 may provide radiologists and/or administrators real time feedback on how long they are taking for the completion of a medical exam to be performed (e.g., diagnosing medical images having the diagnoses dictated, transcribed and approved by the radiologist).

In another example embodiment, one or more other individual performance indicators that may be tracked/monitored by the medical metrics module 78 may relate to a number of peer reviews completed in comparison to a predetermined threshold, a number of peer review discrepancies identified by others against an individual's reported exams, a number of exams read by an individual today, this week, this month, etc.

Every jurisdiction typically has different requirements regarding peer review. For purposes of illustration and not of limitation, presume that 10% of all medical exams that get imaged and reported by an imaging center must be peer reviewed in order to comply with a regulatory requirement. As such, other peer radiologists evaluate the review of medical exams of a particular radiologist to ensure that there are not any discrepancies in an effort to improve the quality of the review of medical exams.

The peer review may be utilized by the medical metrics module 78 as a performance indicator in real time to monitor how many peer review quotas have met and also to monitor a number of discrepancies radiologists of the review panel are finding in other radiologists' work. In this regard, for example an indication that 20 medical exams have been peer reviewed out of 400 exams may be provided to the medical metrics module 78. Additionally, in an instance in which the peer review determines that on average 6 to 8 discrepancies are identified in a radiologist review this information may be input via a user input interface 82 and captured by the medical metrics module 78. As such, the medical metrics module 78 may provide visible indicia to one or more displays (e.g., display 80, display 30) indicating the discrepancies and denoting room for improvement for the radiologist. In one example embodiment, these discrepancies may count against the individual radiologist or against the monthly target for the entire health care facility (e.g., a radiology center).

As such, the radiologist whose exams were identified as having on average 6 to 8 discrepancies may review this information alter their behavior such as, for example, being more careful about reading the exams.

In one example embodiment, one or more metrics may be utilized by the medical metrics module 78 for evaluating technicians (e.g., radiologist technicians). For example, a predetermined threshold (e.g., 5%) of acceptable number of repeat images captures by technicians may be assigned by the medical metrics module 78. In this regard, in an instance in which the medical metrics module 78 detects that the number (e.g., 25%) of repeat images exceeds the predetermined threshold, the medical metrics module 78 may provide visible indicia to one or more displays (e.g., display 30, display 80) indicating the unacceptable level/number of repeat image captures by a corresponding technician. The technician may review this information via a display (e.g., display 30, display 80) in real time and may alter his behavior to minimize the number of repeat image captures.

In an example embodiment, one or more performance indicators regarding pre-qualification vetting may be tracked or monitored by the medical metrics module 78. In this example embodiment, a number of medical exams (medical imaging exams) that are ordered and performed may be considered regarding the appropriateness of the medical exams.

The medical metrics module 78 may track instances in which medical exams (e.g., medical imaging exams) are ordered and performed (e.g., examining images to provide a diagnosis) by health care professions (e.g., radiologists) but the insurance payments for costs of performing the imaging exams are denied for reimbursement. by insurance companies or Medicare and/or Medicaid agencies.

The medical metrics module 78 may track medical exams (e.g., medical imaging exams) that are denied for reimbursement by analyzing data in the memory 86 indicating that a particular exam was denied by a respective insurance company or a Medicare or Medicaid agency. Additionally, the medical metrics module 78 may analyze data in the memory 86 and may identify one or more health care professionals (e.g., radiologists) that performed the medical exams that were denied for reimbursement.

By analyzing the data indicating the medical exams that were denied for payment of reimbursement fees and identifying the particular health care professionals (e.g., radiologists) that performed the medical exams which were denied reimbursement, the medical metrics module 78 may, in some instance, provide feedback to these health care professionals. For example, in an instance in which the medical metrics module 78 determines a health care professional has a number of reimbursements denied exceeding a predetermined threshold (e.g., a predefined value (e.g., 5)) in a time period (e.g., during a month, quarterly, etc.), the medical metrics module 78 may provide visible indicia to a display (e.g., display 80, display 30) indicating to the health care professional that the health care professional has a number of reimbursements being denied that is more than a desirable level. This may influence the health care professional to alter behavior to minimize the number of reimbursements being denied.

In another example embodiment, the medical metrics module 78 may track radiation dosage provided to patients. In this example embodiment, the medical metrics module 78 may monitor radiation dosages received by patients based on information in the memory 86 specifying the amounts of radiation received by patients during tests for particular time periods. The indications of the amount of radiation received by patients may be stored in memory 86 in response to receipt of data indicating the radiation dosages received by patients. The indications may be received in response to input, for example by a health care professional, via the user input interface 82.

By monitoring the radiation received, the medical metrics module 78 may compare the amount of radiation dosage received by a patient(s) in a time period to a predetermined threshold. In an instance in which the medical metrics module 78 determines that a corresponding patient has a radiation dosage in excess of the predetermined threshold (e.g., a predefined value indicating an amount of radiation) during a particular time period, the medical metrics module 78 may provide visible indicia to one or more displays (e.g., display 30, display 80) indicating that a patient(s) received more radiation dosage during a time period than desired in an instance in which the medical metrics module 78 determines that the corresponding the radiation dosage for the patient during the time period excess a predetermined threshold during the particular time period. In this regard, a health care professional reviewing the visible indicia of the display indicating the excess of radiation dosage received by the patient(s) may schedule more appropriate or alternative exams for the patient rather than scheduling another radiation treatment.

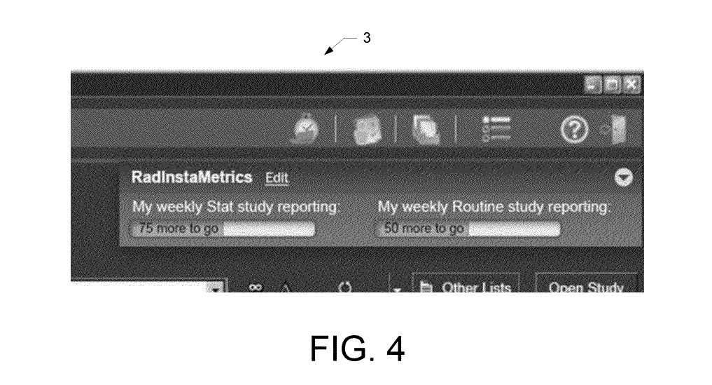

Referring now to FIGS. 4-12, diagrams of user interfaces indicating real-time metrics regarding the progress of certain tasks associated with a health care institution are provided according to an example embodiment. The user interfaces of the FIGS. 4-12 may include data indicating one or more workflow goals that are being tracked by the medical metrics module 78.

Referring now to FIG. 4, a diagram illustrating a user interface of a weekly reporting goal summary according to an example embodiment is provided. The weekly reporting goal user interface 3 may be generated by the medical metrics module 78. The weekly reporting goal user interface 3 may be utilized by one or more health care professionals (e.g., radiologists) to assist the health care professionals in tracking their STAT and routine study reading (e.g., medical image diagnosis) goals. STAT study reading may relate to an urgent exam reading of medical images, for generating a diagnosis, which requires immediate attention. The routine study reading exam may, but need not, relate to an exam reading of medical images, for generating a diagnosis, which may be performed in a non-expedited manner. The information displayed in the weekly reporting goal summary by the medical module 78 indicates how close a health care professional (e.g., a radiologist) is to meeting the designated reading targets during a given week for the STAT study reporting and routine study reporting. In this example embodiment, the medical metrics module 78 determined that health care professional has 75 more STAT readings to review for a given week and 50 more routine study readings for the given week. The medical metrics module 78 may indicate this information (e.g., visible indicia) in the weekly reporting goal summary user interface 3.

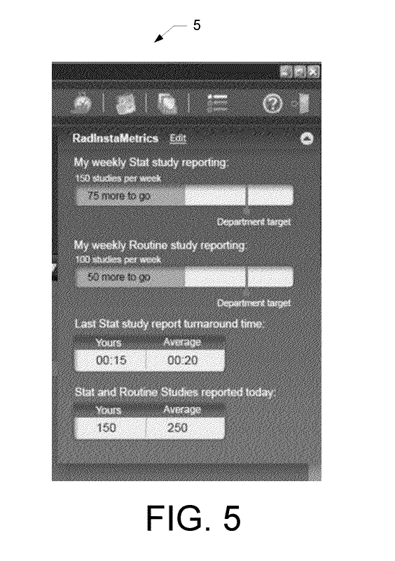

Referring now to FIG. 5, a diagram illustrating a user interface of an expanded weekly reporting goal summary is provided according to an exemplary embodiment. In this example embodiment, the medical metrics module 78 may indicate additional details in the expanded weekly reporting goal summary user interface 5 such as, for example, the last report turnaround time and data that allows a health care professional (e.g., a radiologist) to compare their reading time with that of their colleagues or peers (e.g., other radiologists). Additionally, the medical metrics module 78 may include indicia (e.g., visible indicia) in the expanded weekly reporting goal summary interface 5 indicating a department (e.g., a radiology center of a health care institution (e.g., a hospital)) target, which may assist a health care professional (e.g., a radiologist) in measuring their reporting progress against the established department goal.

In this example embodiment, the medical metrics module 78 may indicate that the health care professional's most recently submitted (e.g., the last) STAT study report turnaround time is 15 minutes and that the average STAT study report turnaround time most recently submitted by peers/colleagues is 20 minutes. This may denote to the health care professional that the turnaround time of most recently submitted STAT study reading of the health care professional is efficient.

Also, in this example embodiment, the medical metrics module 78 may indicate that the total number of STAT and routine study readings submitted by the health care professional as of a current date is 150 whereas the average total number of STAT and routine study readings submitted by the peers/colleagues of the health care professional is 250. This may denote to the health care professional that he is performing inefficiently since peers/colleagues have submitted an average of 100 additional STAT and routine study readings as compared to the STAT and study readings of the health care professional.

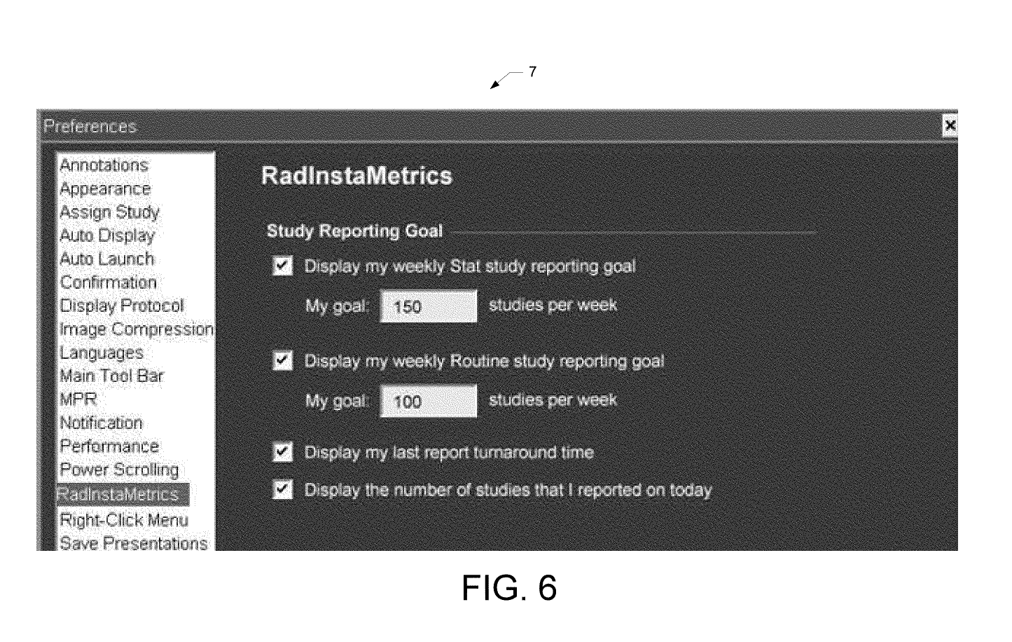

Referring now to FIG. 6, a diagram illustrating a user interface of weekly reporting goal preferences is provided according to an exemplary embodiment. In this example embodiment, the medical metrics module 78 may include data in the weekly reporting goal preferences user interface 7 enabling a health care professional to alter one or more settings by editing their goal preferences. For example, the health care professional may change their study reporting goals regarding the number of STAT and routine reading studies that are to be performed each week and displayed as well as the reporting of the last turnaround time and display of the number of studies that were reported on a current day.

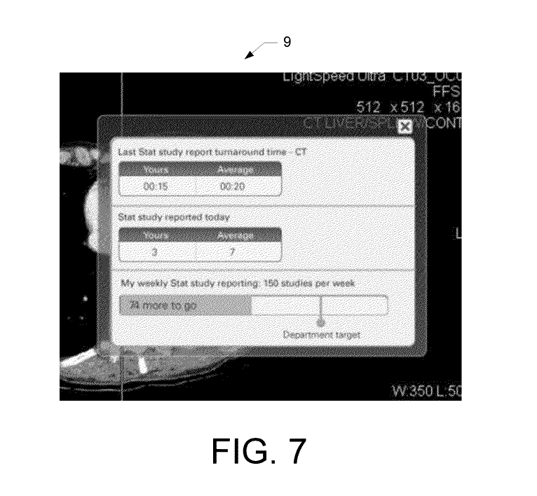

Referring now to FIG. 7, a diagram illustrating a user interface of weekly reporting goals updates is provided according to an exemplary embodiment. The medical metrics module 78 may generate the weekly reporting goal updates interface 9. In an example embodiment, each time a health care professional (e.g., radiologist) has completed reading a study, the medical metrics module 78 may indicate the update in the weekly reporting goal update user interface 9. The weekly reporting goal update user interface 9 may indicate that the STAT study readings reported by the health care professional for a current date is 3 whereas the average number of STAT study readings for peers/colleagues is 7. Additionally, the weekly reporting goal updated user interface 9 may include indicia (e.g., visible indicia) indicating that the health care professional has 74 more STAT study readings to consider to meet the weekly goal of 150 STAT study readings per week in response to receiving an indication that the health care professional has competed the reading of another STAT study.

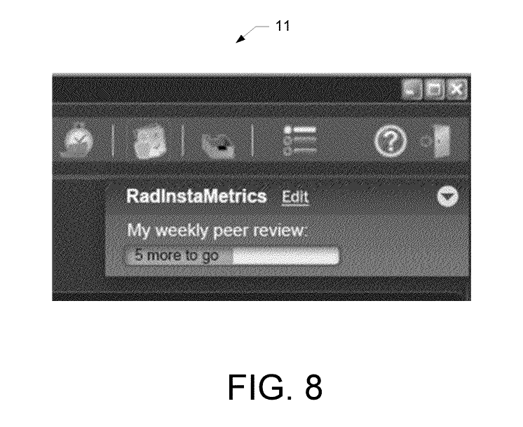

Referring now to FIG. 8, a diagram illustrating a user interface of weekly peer review goals is provided according to an exemplary embodiment. The medical metrics module 78 may generate the weekly peer review goals user interface 11. The weekly peer review goals user interface 11 may be utilized by health care professionals (e.g., radiologists) to assist them in tracking their progress and in conducting peer reviews. The medical metrics module 78 may include indicia (e.g., visible indicia) in the weekly peer review goals user interface 11 indicating to a health care professional (e.g., a radiologist) how close they are to completing their weekly peer review quota at the beginning of and throughout a peer review time period. In this example embodiment, the weekly peer review goals user interface 11 indicates that the health care professional has five more studies of medical exams (e.g., medical imaging exams) of other health care professionals to review.

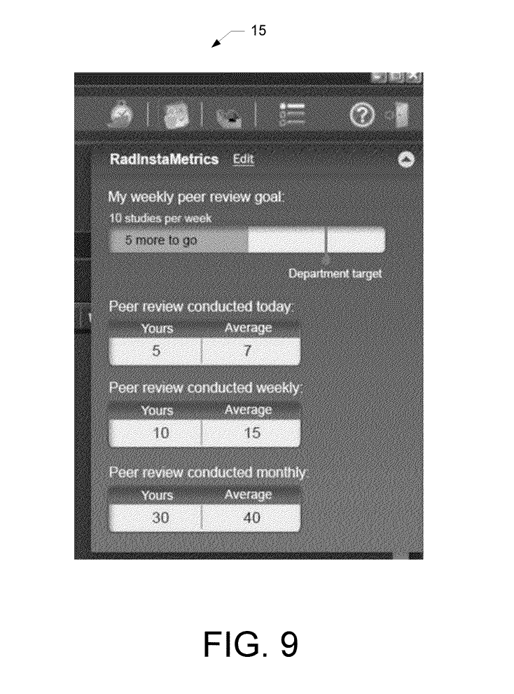

Referring now to FIG. 9, a diagram illustrating a user interface of expanded weekly peer review goals is provided according to an exemplary embodiment. The medical metrics module 78 may generate the expanded weekly peer review goals user interface 15. The medical metrics module 78 may include indicia (e.g., visible indicia) indicating daily peer review statistics and department target goals which may assist a health care professional in measuring their peer review progress against designated department target goals.

The medical metrics module 78 may include indicia (e.g., visible indicia) in the expanded weekly peer review goals user interface 15 indicating the number of studies per week (e.g., 10 studies per week) that are designated as a goal. Additionally, the medical metrics module 78 may include indicia in the expanded weekly peer review goals user interface 15 indicating a number of studies remaining (e.g., five) for peer review to meet the goal.

In the example embodiment of FIG. 9, the medical metrics module 78 may include indicia in the expanded weekly peer review goals user interface 15 indicating that the number of studies peer reviewed by the health care professional on a current date is five whereas the average number of studies peer reviewed by colleagues (e.g., colleagues of a department (e.g., a radiology center) on a current date is seven. The expanded weekly peer review goals user interface 15 may also include data indicating that the number of studies peer reviewed by the health care professional weekly is 10 whereas the average number of studies peer reviewed by colleagues weekly is 15. Moreover, the expanded weekly peer review goals user interface 15 may also include data indicating that the number of studies peer reviewed by the health care professional monthly is 30 whereas the average number of studies peer reviewed by colleagues monthly is 40. By analyzing this information, a health care professional may determine that their production is inefficient in comparison to other colleagues.

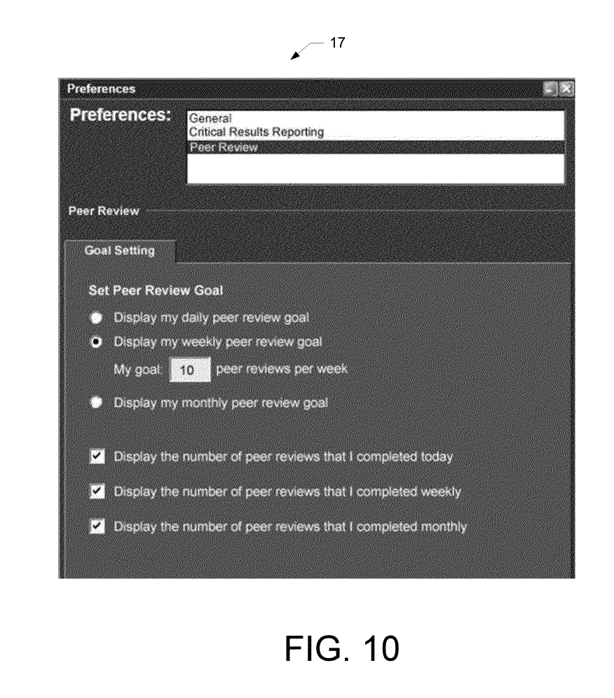

Referring now to FIG. 10, a diagram illustrating a user interface of weekly peer review goal preferences according to an exemplary embodiment is provided. The medical metrics module 78 may generate the weekly peer review goal preferences user interface 17. The weekly peer review goal preferences user interface 17 may enable a health care professional (e.g., a radiologist) to set or change their goals by editing their goal preferences. For instance, the weekly peer review goal preferences user interface 17 may allow a health care professional to change and select display of peer review goals for the week, as well as well as display of number of peer reviews completed for a current day, weekly, and monthly. The weekly peer review goal preferences user interface 17 may also allow a health professional to select display of daily and monthly peer review goals.

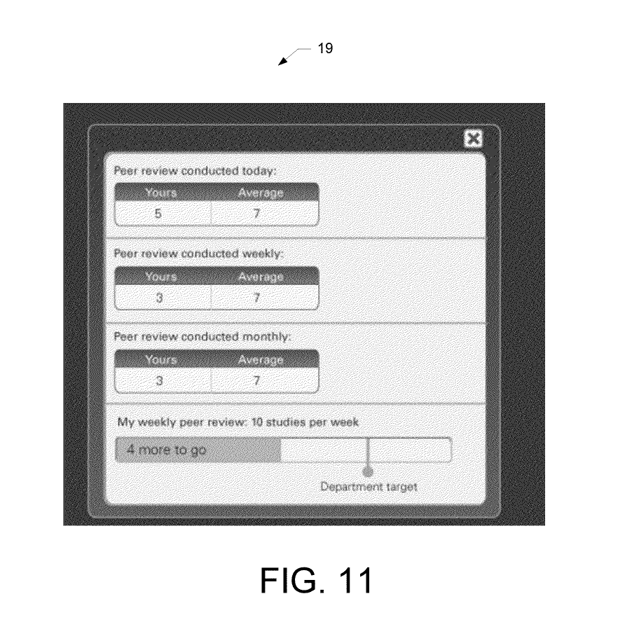

Referring now to FIG. 11, a diagram illustrating a user interface of weekly peer review goal updates according to an exemplary embodiment is provided. The medical metrics module 78 may generate the weekly peer review goal updates user interface 19. The medical metrics module 78 may provide indicial (e.g., visible indicia) to the weekly peer review goal updates user interface 19 each time that the health care professional (e.g., radiologist) has completed reading a study. For example, in an instance in which the medical metrics module 78 receives an indication that a health care professional reviewed another peer review study, the medical metrics module 78 may update the weekly peer review goal updates user interface 19 to indicate the remaining number (e.g., four) of peer review studies for review. The weekly peer review goal updates user interface 19 may also indicate the number (e.g., five) of peer review studies reviewed by a health care professional for a current day in comparison to the average number (e.g., seven) of peer review studies reviewed by colleagues for the current day as well as the number (e.g., three) of peer review studies reviewed by a health care professional for a given week in comparison to the average number (e.g., seven) of peer review studies reviewed by colleagues for the given week. The weekly peer review goal updates user interface 19 may also indicate the number (e.g., three) of peer review studies reviewed by a health care professional for given month (e.g., seven) in comparison to the average peer review studies reviewed by colleagues for the given month.

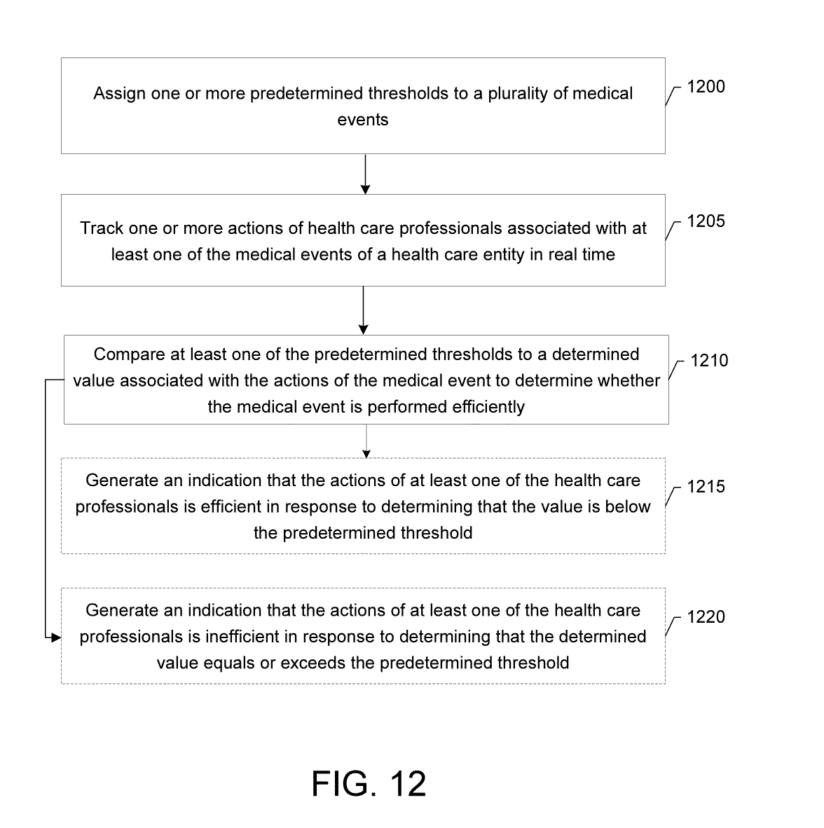

Referring now to FIG. 12, an exemplary method for tracking real time metrics in a health care entity is provided. At operation 1200, an apparatus (e.g., communication device 145) may assign one or more predetermined thresholds to one or more medical events. At operation 1205, an apparatus (e.g., communication device 145) may track or monitor one or more actions of health care professionals associated with at least one of the medical events of a health care entity in real time.

At operation 1210, an apparatus (e.g., communication device 145) may compare at least one of the predetermined thresholds (e.g., a baseline time for performing a STAT study, a designated number of STAT studies for peer review, etc.) to a determined value (e.g., a total time that it takes to perform the actions, a number of medical imaging studies reviewed, etc.) associated with the actions of the medical event (e.g., performing a STAT exam, peer reviewing studies, etc.) to determine whether the medical event is performed efficiently. The health care entity may include a radiology facility or a radiology department (e.g., a radiology department of a hospital or of a university, etc.).

Optionally, at operation 1215, an apparatus may (e.g., communication device 145) may generate an indication that the actions of at least one of the health care professionals (e.g., a radiologist, a radiologist technician, etc.) is efficient in response to determining that the determined value is below the predetermined. Optionally, at operation 1220, an apparatus (e.g., communication device 145) may generate an indication that the actions of at least one of the health care professionals (e.g., a radiologist, a radiologist technician, etc.) is inefficient in response to determining that the determined value equals or exceeds the predetermined threshold. The indication that the actions of the health care professional is inefficient may be provided as visible indicia to a display (e.g., display 30, display 80) which may influence the health care professionals to take corrective action to achieve efficiency when subsequently performing similar actions.

It should be pointed out that FIG. 12 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, medical metrics module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 12 above may comprise a processor (e.g., the processor 70, the processor 34, the medical metrics module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 34, the processor 70 (e.g., as means for performing any of the operations described above), the medical metrics module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
assigning one or more predetermined thresholds to one or more medical events;
tracking one or more actions of health care professionals associated with at least one of the medical events of a health care entity in real time;
comparing, via a processor, at least one of the predetermined thresholds to a determined value associated with the actions of the medical event to determine whether the medical event is performed efficiently; and
enabling provision of visible data to at least one of the health care professionals in real time while the health care professional performs the actions indicating whether the medical event is being performed efficiently, prior to the completion of the actions, to influence behavior of the health care professional to meet a target goal corresponding to the medical event.

2. The method of claim 1, wherein, the health care entity comprises at least one of a radiology facility or a radiology department.

3. The method of claim 2, further comprising:
generating an indication that the actions of the at least one health care professional is efficient in response to determining that the determined value is below the predetermined threshold.

4. The method of claim 2, further comprising:
generating an indication that the actions of the at least one health care professional is inefficient in response to determining that the determined value equals or exceeds the predetermined threshold.

5. The method of claim 3, wherein generating the indication comprises generating visible indicia denoting that the health care professional is efficient.

6. The method of claim 4, wherein generating the indication comprises generating visible indicia indicating that the actions of the health care professional is inefficient.

7. The method of claim 6, wherein indicating that the actions of the health care professional is inefficient denotes that a target goal of the health care entity was not met or that an individual goal of the health care professional was not met.

8. The method of claim 7, wherein the visible indicia indicating that the actions of the health care professional is inefficient serves to influence the health care professional, in real time, to take corrective action to meet the target goal of the health care entity in an instance in which an event of a same type associated with the medical event is subsequently performed.

9. The method of claim 1, wherein:
at least one of the health care professionals comprises a radiologist; and
the medical event is associated with at least one task involving medical imaging.

10. An apparatus comprising:
at least one memory; and
at least one processor configured to cause the apparatus to:
assign one or more predetermined thresholds to one or more medical events;
track one or more actions of health care professionals associated with at least one of the medical events of a health care entity in real time;
compare at least one of the predetermined thresholds to a determined value associated with the actions of the medical event to determine whether the medical event is performed efficiently; and
enable provision of visible data to at least one of the health care professionals in real time while the health care professional performs the actions indicating whether the medical event is being performed efficiently, prior to the completion of the actions, to influence behavior of the health care professional to meet a target goal corresponding to the medical event.

11. The apparatus of claim 10, wherein, the health care entity comprises at least one of a radiology facility or a radiology department.

12. The apparatus of claim 11, wherein the processor is further configured to:
generate an indication that the actions of the at least one health care professional is efficient in response to determining that the determined value is below the predetermined threshold.

13. The apparatus of claim 11, wherein the processor is further configured to:
generate an indication that the actions of the at least one health care professional is inefficient in response to determining that the determined value equals or exceeds the predetermined threshold.

14. The apparatus of claim 12, wherein the processor is further configured to cause the apparatus to:
generate the indication by generating visible indicia denoting that the health care professional is efficient.

15. The apparatus of claim 13, wherein the processor is further configured to cause the apparatus to:
generate the indication by generating visible indicia indicating that the actions of the health care professional is inefficient.

16. The apparatus of claim 15, wherein indicating that the actions of the health care professional is inefficient denotes that a target goal of the health care entity was not met or that an individual goal of the health care professional was not met.

17. The apparatus of claim 16, wherein the visible indicia indicating that the actions of the health care professional is inefficient serves to influence the health care professional, in real time, to take corrective action to meet the target goal of the health care entity in an instance in which an event of a same type associated with the medical event is subsequently performed.

18. The apparatus of claim 10, wherein:
at least one of the health care professionals comprises a radiologist; and
the medical event is associated with at least one task involving medical imaging.

19. A computer program product comprising at least one non-transitory computer-readable storage medium having computer-executable program code instructions stored therein, the computer executable program code instructions comprising:
program code instructions configured to assign one or more predetermined thresholds to one or more medical events;
program code instructions configured to track one or more actions of health care professionals associated with at least one of the medical events of a health care entity in real time;
program code instructions configured to compare at least one of the predetermined thresholds to a determined value associated with the actions of the medical event to determine whether the medical event is performed efficiently; and
program code instructions configured to enable provision of visible data to at least one of the health care professionals in real time while the health care professional performs the actions indicating whether the medical event is being performed efficiently, prior to the completion of the actions, to influence behavior of the health care professional to meet a target goal corresponding to the medical event.

20. The computer program product of claim 19, further comprising:
program code instructions configured to generate an indication that the actions of the at least one health care professional is inefficient in response to determining that the determined value equals or exceeds the predetermined threshold.
